(19) United States
(12) Patent Application Publication
(10) Pub. No.: US 2026/0086267 A1
(43) Pub. Date: Mar. 26, 2026

(54) COMPUTER-IMPLEMENTED METHOD FOR UNDERGROUND OR SUBSURFACE RESERVOIR SIMULATION DURING AN INJECTION OF A FLUID AND RELATED NON-TRANSITORY COMPUTER READABLE MEDIUM

(71) Applicant: TotalEnergies OneTech, COURBEVOIE (FR)

(72) Inventors: Wan Firda Asila WAN MUHAIMIN, PAU Cedex (FR); Alejandro RODRIGUEZ MARTINEZ, PAU Cedex (FR); Ghislain PUJOL, PAU Cedex (FR)

(73) Assignee: TotalEnergies OneTech, COURBEVOIE (FR)

(21) Appl. No.: 19/110,141

(22) PCT Filed: Sep. 13, 2022
(86) PCT No.: PCT/IB2022/000534

§ 371 Date: Mar. 10, 2025

(51) Int. Cl. G01V 20/00; E21B 47/022; E21B 49/00

(52) U.S. Cl. CPC G01V 20/00; E21B 47/022; E21B 49/008; E21B 2200/20

(57) ABSTRACT

Reading geological and geomechanical constants of a reservoir and selected feature of the fluid injection; associating a grid with the reservoir; determining an expected fracture direction from the wellbore based on the geomechanical constants; flagging the cells of the grid along the expected fracture direction as fracture prone cells; and running an analytical flow model on the grid. The analytical flow model being iterated over a plurality of time steps, each step leading to the calculation of a current pressure. The model inputting geological and geomechanical constants, selected features, and flow properties of each cell and step, calling a fracture function to determine if each cell among the fracture prone cells is affected by fractures. The fracture function inputs the current pressure in each fracture prone cell, and if a particular fracture prone cell is affected by fractures, adjusting the flow properties of the cell for the following time step.

### CROSS REFERENCE TO RELATED APPLICATIONS

The present application is a U.S. National Phase Application under 35 U.S.C. § 371 of International Patent Application No. PCT/IB2022/000534 filed Sep. 13, 2022. The entire contents of which are hereby incorporated by reference.

### FIELD

The present invention pertains to the technical fields of computer-implemented methods for underground or subsurface reservoir simulation during injection of a fluid.

When fluid is injected, in particular cold fluid leading to the cooling of the rock formation of the reservoir, fractures may appear, modifying locally the flow properties of the fluid.

For example, Carbon Capture and Storage—CCS (also called carbon capture and sequestration) in depleted gas fields consists in injecting CO₂ in a depleted gas field acting as a reservoir.

CCS in depleted gas fields is attractive due to the proven sealing capacity of the gas fields, as demonstrated by the long-term containment of methane or other light hydrocarbons.

### BACKGROUND

The storage of CO₂ in a depleted gas field involves the injection of liquid CO₂ (or more precisely of a CO₂ rich liquid) under high pressure and low temperature. The pressure reaches typically between 80 and 150 bara (absolute bar unit) at the bottom hole during an initial phase of the injection process, and then, once the injection makes the reservoir increase its pressure, the pressure at the bottom hole can reach up to 400 bars or more, as needed to continue the injection. Typically, the temperature is between −15 and −10° C. in the reservoir near the wellbore during the initial phase.

The CO₂ injection thus leads to the propagation of both a temperature front and a pressure front away from the wellbore.

The pressure front may locally exceed the fracture initiation pressure of the rock formation, causing appearance and propagation of fractures.

In addition, the temperature front brings a reduction of the in-situ stresses of the rock formation of the reservoir, which in turn causes a decrease of the fracture initiation pressure. In combination with the injection overpressure, this increases the risk of creation of fractures, called in this particular case Thermally Induced Fractures—TIFs.

The risk of tensile failure leading to fractures in the rock formation is among the main geomechanical uncertainties in the prediction of the performances of a reservoir. This is due to the uncertainty in the injectivity index over time, which is caused by the fractures induced into the rock formation during the fluid injection process. These fractures, which are expected to develop radially from the wellbore, improve in fact the injectivity index of the reservoir, which could be increased by several orders of magnitude in extreme cases.

### SUMMARY

Understanding, in a predictive way through reservoir simulation, the occurrence or not of fractures, in particular thermally induced fractures, when would it happen, its governing parameters or its evolution through time, are critical questions that need to be evaluated when planning an injection well, in particular for CCS, at least to define expected performances of the reservoir, such as the total volume of fluid expected to be stored in the reservoir.

It is to be noted that the capacity of estimating the properties of the fractures, such that their extension or other geometrical properties, is a very important result of a simulation method, since it affects the sealing capacity of the cap rock and nearby fault integrity and stability of the reservoir which are other examples of quantities characterizing the performances of the reservoir.

Consequently, there is a need for simulation tools describing the behavior of a reservoir during the fluid injection process (dynamic part of the simulation), but also over a period of time after the injection process (relaxation part of the simulation).

### Flow (in Particular Thermal Flow) and Fracture Physics are Coupled

One approach would consist in running one analytical global model for simulating both the flow physics and the fracture physics. However, it implies nonlinear equations that are difficult to solve or approximate. Such an analytical model would then be very complex to program and would require extensive resources in terms of computational power and time. In addition, there is also a major problem related to the grid on which such analytical model would run. Indeed, the grid usually used for fracture simulations has unstructured cells for simplifying the geomechanical equations, whereas the grid usually used for flow simulations has regular cells for simplifying the flow equations. It is not practical, even impossible, to define a common grid on which an analytical global model could run.

Another approach consists in running in an interleaved manner two analytical models, one dedicated to flow physics and another one dedicated to fracture physics. However, such an approach still requires wide computational power and time.

Consequently, there are currently no efficient reservoir simulation software for the coupling of fracture and flow physics.

The invention therefore aims to overcome this problem, in particular by providing a reservoir simulation able to predict explicit fracturing of reservoir in any case of injection.

To this end, the object of the invention is to provide a method and a computer readable medium according to the claims.

### BRIEF DESCRIPTION OF THE DRAWINGS

Further features and advantages of the invention will become more apparent from the description, which is illustrated by way of non-limiting example in the drawings, which:

FIG. 1 is a general schematic representation of a preferred embodiment of the simulation method according to the invention; and

FIG. 2 is a two-dimensional representation of the reservoir subjected to liquid injection from a wellbore.

### DETAILED DESCRIPTION

Generally speaking, the present invention relates to the improvement to existing analytical flow model used in reservoir simulations, with the provision of a fracture function that can be called to test whether or not cells of the grid on which the flow model is running are affected by fractures.

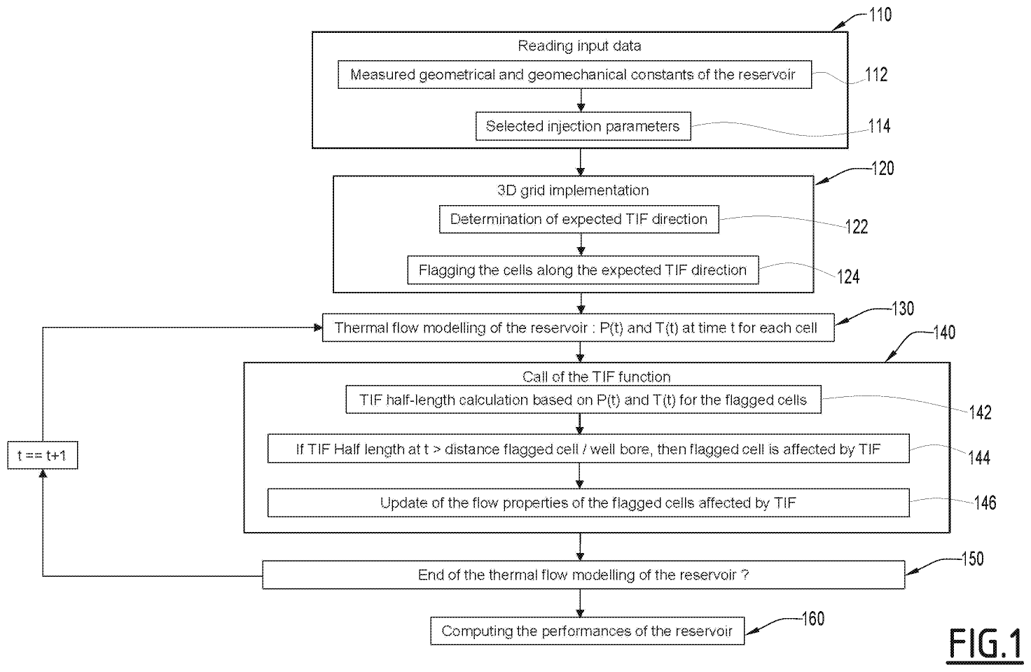

FIG. 1 illustrates a preferred embodiment of a method 100 for reservoir simulation according to the invention. The disclosure of the method will be exemplified on the particular case of CCS in a depleted gas field.

This method is implemented on a computer. A computer comprises computing means, such as a processor, and storage means, such as a memory. The memory stores the instructions of computer programs, in particular a program whose execution allows the implementation of the method 100.

The aim of the simulation is to be able to evaluate the performances of the depleted gas field intended to be used as a CO₂ reservoir.

Step 110 consists in reading input data, for example from a database.

More particularly, sub-step 112 consists in reading measured geological and geomechanical constants describing the reservoir.

For example, engineers measure geological constants related to the reservoir (such as the reservoir thickness, the reservoir temperature, etc.) and to the or each wellbore used for the injection (such that the wellbore position relative to the reservoir, the wellbore geometry, etc.), but also to the nature of the rock formation, i.e. petrophysics data (porosity, permeability, anisotropy, saturation, etc.), for various points in the reservoir.

The engineers also measure geomechanical constants of the rock formation throughout the reservoir, such that: maximum and minimum in situ stresses and directions, Young Modulus, Poisson Ratio, etc.

More particularly, sub-step 114 consists in reading selected features for the injection parameters. For example, the flow rate and the pressure and temperature of the fluid at the bore-head are defined. These features can be time dependent. From these features, it is then possible to compute the fluid pressure and temperature at the bottom of the wellbore, where the fluid is injected into the reservoir.

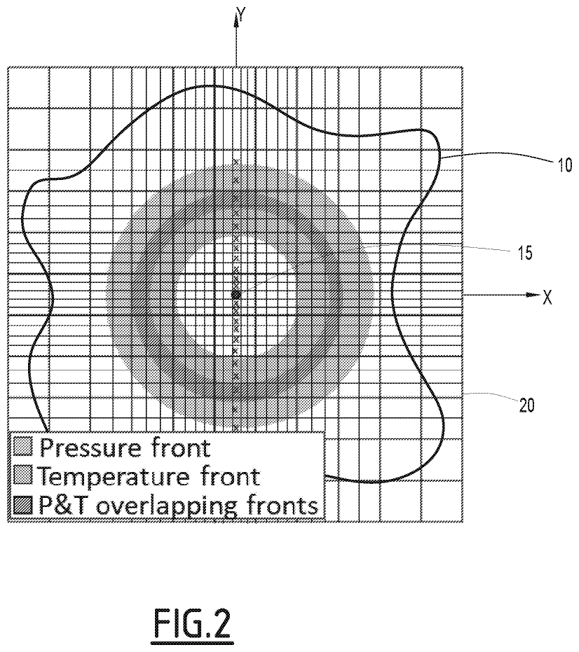

In step 120, a three-dimensional grid of cells is associated with the reservoir. As shown in FIG. 2, in a two-dimensional view of a horizontal layer of the reservoir 10, the grid 20 is made up of a plurality of cells.

The grid is centered on the wellbore 15. Preferably, the grid is a cartesian grid, but it could alternately be a cylindrical grid or any other suitable discretization of the reservoir to be modelled.

Preferably, the size of each cell of the grid is constant throughout the reservoir. Alternatively, the cell size depends on the distance from the wellbore, what could be beneficial to the computational efficiency of the method.

In sub-step 122, an expected fracture direction is determined based on the measured geomechanical constants gathered in step 110.

When a fracture occurs, its direction (or fracture direction) is always aligned with the maximum local stress. Thus, a fracture always propagates from the wellbore along the maximum local stress line.

Thus, the in situ max stress measured by the geomechanical survey of the site gives the expected fracture direction along which a fracture (in particular a thermal induced fracture) will appear and grow. This expected fracture direction is fixed and assume to be constant (although minor changes may take place under injection).

In the present description, for sake of simplicity of the disclosure, it is assumed that the expected fracture direction is oriented along the Y direction of the grid 20.

In sub-step 124, the cells of the grid which are aligned with the expected fracture direction are flagged as “fracture prone”, since they are the cells of the grid most likely to be affected by fractures, when this phenomenon occurs. These flagged cells are marked with a cross in FIG. 2.

Step 130 consists in running an analytical flow model dedicated to model the flow of the injected liquid in the reservoir.

The analytical flow model is an iterative algorithm. It is repeated at each time step of a plurality of time steps subdividing the time period on which the behavior of the reservoir is simulated.

In the specific case of TIFs, this algorithm is an analytical thermal flow model, which is able to compute the actual temperature evolution in the reservoir, in addition to the actual pressure evolution in the reservoir.

For example, the analytical thermal flow model used is the “Eclipse 300” software developed by Schlumberger.

At each time step, the inputs of the analytical thermal flow model are: the measured geological constants; the selected features for the injection; the current grid parameters; and the past values of the flow quantities (pressure and temperature as determined by the previous iteration of the flow model).

The current grid parameters are related to the shape of grid as previously defined (its geometry, its connectivity, etc.), but also to current values of flow properties of the grid (for example descriptors of how the flow should behave from one cell to another).

Each time step t leads to the computation of the current values of the flow quantities, in particular pressure P(t) and temperature T(t) in each cell of the grid 20. Additional quantities describing the flow could also be computed, such as for example the saturation of each fluid.

According to the invention, the analytical flow model is improved so as to include, at each time step t, the call to a fracture function (step 140).

This fracture function is called when the grid 20 comprises at least one cell that has been flagged as potentially affected by TIFs in sub-step 124.

As a consequence, in step 140, the fracture function is executed.

The fracture function comprises the calculation of a current fracture property (sub-step 142), followed by the verification of a criteria (sub-step 144) based on the current fracture property, and when the criteria is met, the update of flow features of the cells of the grid affected by TIFs (sub-step 146).

Sub-step 142 involves the calculation of at least the fracture half-length. Other properties of the fractures could be calculated as an improvement of the method, such that the fracture aperture, the fracture height, etc.

The fracture half-length calculation is based on an approximate formula.

The approximate formula is preferably a parametrical function of one or several configuration parameters. These configuration parameters are the measured geological and geomechanical constants.

The inputs of the approximate formula are the current values of the flow quantities for each flagged cell as output by the thermal flow model for the current time step, i.e. the current radial temperature profile and the current radial pressure profile along the expected TIF direction.

Two vectors of decimal values, respectively the radial pressure profile, (Pcell-1,Pcell-2, . . . Pcell-n) and the radial temperature profile, (Tcell-1, Tcell-2, . . . Tcell-n), makes up the entries of the approximate formula, where 1 to n are indexes of the flagged cells.

The approximate formula is the result of a number of well-known calculations and interpolations of the equations governing fracture physics when considering only the cells along the expected fracture direction, given the pressure and temperature profiles along the expected fracture direction.

Each time it is called, the fracture half-length calculation returns a decimal value corresponding to the half-length of the fracture. The fracture half-length is a global value with an instantaneous validity, adapted to the flow simulation history until the current time step.

If the fracture half-length is equal to zero, there is no fracture in the reservoir. On the contrary, if the fracture half-length is positive then, fractures are present in the reservoir.

When the fracture half-length is positive, then the fracture criteria to be verified in sub-step 144 consists, for each flagged cell, to compare the distance between the center of that flagged cell and the wellbore with the fracture half-length. A flagged cell is said to be affected by fractures when its distance to the wellbore is smaller than the current fracture half-length, and to be not affected by fractures otherwise.

In sub-step 146, if at least one flagged cell is affected by fractures according to sub-step 144, the at least on flow property of the flow model is adjusted to model the actual fracture onset.

Indeed, the flow properties of the grid used to compute flow through one cell and/or from cell to cell need to be adapted in order to better take into account the existence of fractures. The flow properties adjustment should be anisotropic, following the expected fracture direction.

The flow properties that are adjusted may be flow properties of cells of the grid, in particular the cells affected by TIFs, such as the permeability of one cell.

The flow properties that are adjusted may also be flow properties between two neighboring cells of the grid, in particular two flagged cells affected by TIFs. For example, the transmissibility between two cells.

Depending on how the analytical flow model is designed, the adjustment of one or several flow properties can be done explicitly by modifying the value of a cell or an inter-cell parameter, or implicitly by activating flow modifying features in the flow model, such a “pipe” object between the wellbore and the cells affected by TIFs.

In the preferred embodiment, the flow property that is updated is the transmissibility between the fracture affected cell and its neighboring cell that is aligned with the expected fracture direction away from the wellbore.

For example, a precomputed multiplier is applied to the original transmissibility between two cells as determined by the measured geological constants. Alternatively, the current transmissibility can be the result of a timely computation depending on the prediction of the fracture aperture or any other available quantity in the flow model or calculated by the approximation formula.

Consequently, at the next time step, the analytical thermal flow model, which takes into account the current flow properties of all the cells of the grid, will take into account the adjusted flow properties. Consequently, the effects of the occurrence of fractures will be embedded into the pressure and temperature calculated in the following time-step.

The end of the execution of the analytical thermal fluid model occurs (step 150) when a convergence criteria is verified (such that the stability of the temperature and pressure estimated across the reservoir or the pressure and/or temperature inside the reservoir have reached a predefined target).

The analytical thermal fluid model provides actual time evolution profiles of all the properties in the reservoir and well(s).

Advantageously, one or several quantities characterizing the performances of the reservoir are calculated in step 160. The quantity calculated is for example an injectivity per well, a time evolution of injectivity per well, a total storage capacity, a containment integrity risk and/or a well integrity risk, etc.

For example, the injectivity of the well(s) into the reservoir is computed by the time integration of flow rate of the fluid injected into the reservoir according to the analytical thermal flow model.

This method may be executed several times, each time with a different set of values of the injection parameters, or time profile of the injection parameters, to assess the effect of these modifications on the performances of the reservoir.

Even if the preferred embodiment disclosed above is focusing on CCS, the present method could be applied for any type of underground or subsurface reservoir and fluid injection, such as water injection, cold water injection, hydraulic fracking, gas storage, dense fluid injection, etc.

The method is still valid if there is no access to temperature modelling. Indeed, some fluid injections could be understood as isothermal injections and still, fractures are possible and could be modelled with this method. These would not be called TIF, but these would still be fractures with the same impact and could be modelled in the same way.

The fracture function takes as inputs only rock, reservoir, well and fluid properties, and not an injection profile. In an alternative embodiment, where the measured data are provided with uncertainties, the fracture function can be viewed as a parametrical function on these measured data.

This invention is a pragmatic workflow to dynamically integrate the geomechanical features with thermal fluid flow effects in a reservoir simulation in order to gain understanding of the fracture phenomenon with minimal increases in either computation time and complexity. Such a new workflow must be based on fluid physics, geomechanics and good practical sense of modelling.

Indeed, time evolution of TIF is a very important issue that could be tackled by such an approach, since the geomechanical system would be approximately solved in each and every timestep, covering the evolution of the reservoir over the time scope of the project.

The simulation according to the present invention establishes a viable approach (i.e. realistic in workflow and simulation times) to capture the onset and effects of the thermally induced fractures on fluid flow in the reservoir.

As it will be apparent for the person skilled in the art, the input and the computation data at each time step are all either constants of the reservoir or in situ time step calculated data by the flow simulation. Therefore, the preprocessing of the TIF modelling input data is not iterative, but rather a one step process. Once the geomechanics calculation methods are provided, the simulations are autonomous and do not need to cycle back to geomechanics except for reservoir eventual model updates.

This allows taking into account the apparition of said fractures for the operation of the well.

While the fracture function could be called by a single flagged cell or any other process in the reservoir simulator, the result of the call is fully independent of the caller and depends on the data provided, by the caller, as input of the calculation. Indeed, a set of data values have to be provided each time the fracture function is called. These values will be taken from the reservoir simulator at the current time step.

1. A computer-implemented method for underground or subsurface reservoir simulation during an injection of a fluid, comprising the steps of:
reading measured geological and geomechanical constants of the reservoir and selected features of the injection of the fluid at a wellbore in the reservoir;
associating a grid of cells with the reservoir;
determining an expected fracture direction from the wellbore based on the measured geomechanical constants;
flagging the cells of the grid along said expected fracture direction as fracture prone cells;
running an analytical flow model on the grid of cells, the analytical flow model being an algorithm iterated over a plurality of time steps, each time step leading to the calculation of a current pressure for each cell of the grid, the analytical flow model taking as input the measured geological and geomechanical constants, the selected features of the injection, and flow properties of the grid; and,
for each time step of the plurality of time steps, calling a fracture function to determine whether or not each cell among the fracture prone cells is affected by fractures due to the injection of the liquid, the fracture function taking as input the current pressure in each of the fracture prone cells, and if it is determined that a particular fracture prone cell is affected by fractures, adjusting the flow properties of said particular fracture prone cell for the following time step of the analytical flow model.

2. The computer-implemented method according to claim 1, wherein, the fractures due to the injection of the fluid being induced by the temperature of the fluid that is injected, the analytical flow model is an analytical thermal flow model, which further calculates, at each time step, a current temperature for each cell of the grid, the fracture function taking also the current pressure in each of the fracture prone cells as inputs.

3. The computer-implemented method according to claim 1, wherein the reservoir is a depleted gas field and the fluid that is injected is a CO₂ rich fluid.

4. The computer-implemented method according to claim 1, wherein the fracture function uses an approximate formula for calculating a current fracture quantity, and a criteria based on said current fracture quantity to determine whether or not each cell among the fracture prone cells is affected by fractures.

5. The computer-implemented method according to claim 4, wherein the current fracture quantity is the current fracture half-length, and the criteria consists in comparing the distance between the center of the fracture prone cell and the wellbore with the current fracture half-length, the fracture prone cell being said affected by fractures when said distance is inferior to the current fracture half-length.

6. The computer-implemented method according to claim 4, wherein adjusting the flow properties of a particular fracture prone cell is applying a predefined multiplier to the transmissibility between said particular fracture prone cell and its neighboring fracture prone cell away from the wellbore along the expected fracture direction.

7. The computer-implemented method according to claim 1, wherein the measured geomechanical constants comprise in situ stresses and the expected fracture direction is determined as being aligned with the maximum of the in situ stress.

8. The computer-implemented method according to claim 1, further comprising, after the completion of the analytical flow model, the step of computing performances of the reservoir from results of the analytical flow model.

9. The computer-implemented method according to claim 8, wherein the performance of the reservoir computed is an injectivity per well, a time evolution of injectivity, a total storage capacity, a containment integrity and/or a well integrity.

10. Non-transitory computer readable medium storing instructions that, when executed by a processor of a computer, causes the computer to perform a method according claim 1.
